(19) United States
(12) Patent Application Publication
(10) Pub. No.: US 2020/0396088 A1
(43) Pub. Date: Dec. 17, 2020

(54) SYSTEM AND METHOD FOR SECURELY ACTIVATING A MOBILE DEVICE STORING AN ENCRYPTION KEY

(71) Applicant: iCrypto, Inc., Beaverton, OR (US)

(72) Inventor: Adarbad Master, Oldsmar, FL (US)

(73) Assignee: iCrypto, Inc., Beaverton, OR (US)

(21) Appl. No.: 16/764,158

(22) PCT Filed: Nov. 14, 2018
(86) PCT No.: PCT/US2018/060936

§ 371 Date: May 14, 2020

Related U.S. Application Data
(60) Provisional application No. 62/585,753, filed on Nov. 14, 2017.

(51) Int. Cl. H04L 9/32; H04L 9/08; H04W 12/06; H04W 12/00

(52) U.S. Cl. CPC H04L 9/3268; H04L 9/0825; H04L 9/085; H04W 12/001; H04W 12/0609

(57) ABSTRACT

A method of establishing a secure connection between an application on a device and a host server without requiring that the necessary client and server-side certificates to be neither pre-installed, physically moved and loaded or transmitted in the clear. The authentication of the mobile network is directly used to generate the keys required to effect the secure connection. PKI pairs ultimately generated for this connection are securely stored by segmentation storage in a manner that allows the secure connection to be reestablished by recovering only some of the parts as defined by the segmentation algorithm.

### CROSS-REFERENCE TO RELATED APPLICATIONS

This application claims the benefit of the filing date of U.S. Provisional Patent Application No. 62/585,753, which was filed Nov. 14, 2017, the disclosure of which is hereby incorporated by reference herein in its entirety.

### BACKGROUND

Authentication of devices to networks and networks to devices is a critical process in the modern communications network. Common practice is to allow software clients (browsers, and applications) to connect to servers using well understood authentication methods of public key exchanges and certificates. With a real person involved at the client end, a password or other token known by the person is also entered to secure the connection. However, with the use of machines accessing the servers, there may never be a person involved and no user token is possible. These machines are sometimes referred to as Internet of Things (IOT) devices. IOT devices then have no option but to emulate a person and use some authentication method. There are many types of IOT devices, but herein we are considering only those that have embedded SIM modules and are bootstrapped (authenticated) by a mobile network (PLMN) carrier. To accomplish this, they may follow the 3GPP standard, 33.220, Title: Generic Authentication Architecture (GAA), Generic Bootstrapping Architecture (GBA) to establish the authentication of the device to the network. While this process is effective, it only establishes a trust relationship between the device and the wireless network leaving application to server trust relationship management to other methods.

The existing art uses the device to network connection as any generic communications channel and so uses generic authentication methods. These methods rely on certificates installed in the client (client-side certificates) and certificates installed on the server side. In this way, bi-directional trust can be established between the application and the server. With IOT devices there is necessarily no browser with pre-installed certificate authorities. The entire trust model has to be established by pre-loading IOT devices with client and server certificates and private keys. This pre-loading precludes dynamic configuration of the IOT device and is not scalable. Furthermore, certificates must be changed periodically (typically every 2 years) and new services may need to be supported by the same device.

The subject invention addresses these short comings in the existing art by using the established trust between the SIM based device and the mobile network to enable the creation of a secure channel within which to dynamically load certificates as required—during bootstrap, when updating or refreshing certificates or when adding new services.

### SUMMARY OF THE INVENTION

The subject invention uses the trust level already built into all cellular networks. Any device requesting service from a cellular network (PLMN—Public Land Mobile Network) is required to authenticate itself with a Home Location Register (HLR) or a Home Subscriber Server (HSS) as further defined in the applicable 3GPP standards, with standard 29.336 Rel 11 describing the current standard. IOT devices use the GBA standard process to establish this trusted connection with the end result that the parameters B-TID and KsNAF are now available by the client and the server. The subject invention uses the KsNAF (key) now known to both ends of the connection to establish a PSK-TLS connection. By using this commonly known key, each side can establish the secure connection without the need to transmit any public key or item, greatly increasing the security of the established connection. Using this secure tunnel, the appropriate certificate is transferred to the application on the device allowing the application to further authenticate with the server application without any modifications that maybe required to any other art.

While this summary describes the use of KsNAF, in another embodiment, a similar key, Ks is created and used in a similar manner. The subject invention does not rely on which key is used, but on the fact that a key is known to both ends of the channel and that said key was created by some secure means.

Should the IOT device lose power or for some reason need to be restarted, the subject invention teaches a method that prevents the need to re-cycle the full authentication by securely storing the required PKI private key in the SIM. Securely storing information in a SIM is disclosed in application PCT/US18/46087 (Secure SIM) which is owned by the same applicant as the subject invention. The subject invention increases the practically of said Secure SIM storage by using Shamir's Secret Sharing algorithm which allows the stored information to be recovered without recovering all the parts. Shamir's Secret Sharing algorithm is widely described in published literature with Wikipedia having a fine discussion of the process.

### BRIEF DESCRIPTION OF THE DRAWINGS

Having thus described the invention in general terms, reference will now be made to the accompanying drawings, wherein:

FIG. 1 describes, at a high level, the fundamental flow.

FIG. 2 describes the standard GBA flow.

FIG. 3 describes one embodiment of the invention based on GBA.

FIG. 4 describes the message flow using GBA

FIG. 5 describes the message flow without using GBA

FIG. 6 describes the transfer of the certificate

FIG. 7 is an example schematic of a user device or a server in accordance with some embodiments.

### DETAILED DESCRIPTION

The invention will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

All terms not expressly defined herein shall have the same meaning as provided by the 3GPP standards, 3GPP TR 33.823 V12.01.0 (20122013-1206) or 3GPP TR 21.905 V15.0.0 (2018-03), or normal use within the context of communications and computers. Whenever there is conflict between the 3GPP standards and normal use, the 3GPP standard shall prevail in the respective order above.

A UE has a very rigorous authentication process with the network. Private keys per device are stored in the HSS or HLR per the respective 3GPP standards. References herein to HSS shall be read to include either HSS or HLR. Before the UE can connect and use services of the MNO network, it must pass this authentication process. By using this existing authentication infrastructure, security can be assured without transferring critical keys or certificates.

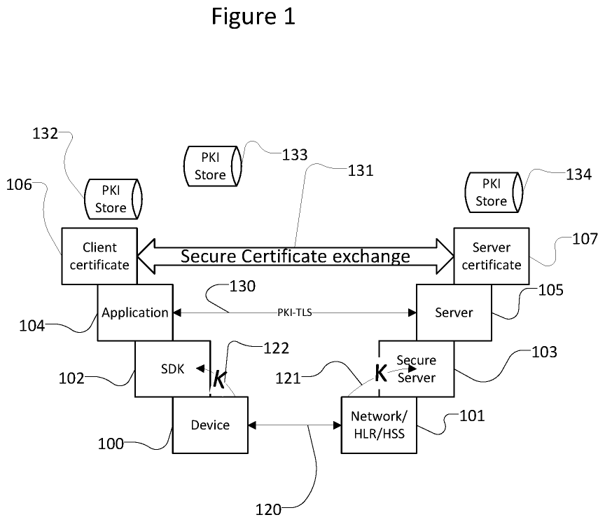

FIG. 1 depicts the overall subject invention as described by the following steps;
Step 1. Device (100) authenticates with Network (101) using any standard authentication mechanism (120).
Step 2. A key K is generated by the process of step 1 and is available to SDK (102) and Secure Server (103).
Step 3. Using key K, which is the same for both SDK (102) and Secure Server (103), the Application (104) and Server (105) can connect using the PKI-TLS connection (130).
Step 4. Once this secure channel is established, Application (104) and Server (103) can each standard client certificate (106) and server certificate (107)
Step 5. The PKI pair is then segmented and stored in parts in PKI store, (132, 133 and 134). Alternatively, the PKI pair can be segmented and store only in the SIM contained in Device (100)

With this understanding of the subject invention, the details of embodiments are now described.

The process may start with a GBA bootstrap. GBA is standardized by 3GPP (3GPP TS 33.220 V15.3.0 (2018-09). The user authentication is instantiated by a shared secret, one in the smartcard, for example a SIM card inside the mobile phone and the other is on the HSS. This shared secrete is provisioned into the SIM and HSS by well know techniques that ensure that said shared secret remains secrete. As the integrity of the mobile network depends on this, the security of said shared secret can be relied upon.

GBA authenticates devices by a network component challenging the smartcard and verifies that the answer is the one predicted by the HSS. The BSF is introduced to the UE by the application server (NAF), after an unknown UE device is trying to obtain service access: the NAF refers the UE to the BSF. UE and BSF mutually authenticate via 3GPP protocol AKA (Authentication and Key Agreement); additionally, the BSF sends related queries to the HSS. Afterwards, UE and BSF agree on a session key to be used for encrypted data exchange with the application server (NAF). When the UE again connects to the NAF, the NAF can obtain the session key as well as user specific data from the BSF and can start data exchange with the end device (UE), using the related session keys for encryption.

Instead of asking the service provider to trust the BSF and relying on it for every authentication request, the BSF establishes a shared secret between the SIM card and the service provider. This shared secret is limited in time and for a specific domain. FIG. 1 shows the high-level creation of the secure tunnel to pass the certificates. The steps depicted in FIG. 1 are:
Step 1. Device (100) initiates GBA boot strap (120) to the network (101) according to said 3GPP standards.
Step 2. Once authenticated, the key (122) is passed to SDK (102) and key (121) is passed to Secure Server (103).
Step 3. Application (104) having access to SDK (102) and Server (105) having access to Secure Server (103) each uses the respective key passed to them in Step 2 above.
Step 4. Application (104) and Secure Server (105), each having access to key (122) and key (121) respectfully are able to negotiate and establish the secure PKI-TLS tunnel (130).
Step 5. Application (104) and Secure Server (105), having established the secure tunnel (130) can now exchange certificates to authenticate the application (104) to Secure Server (105).

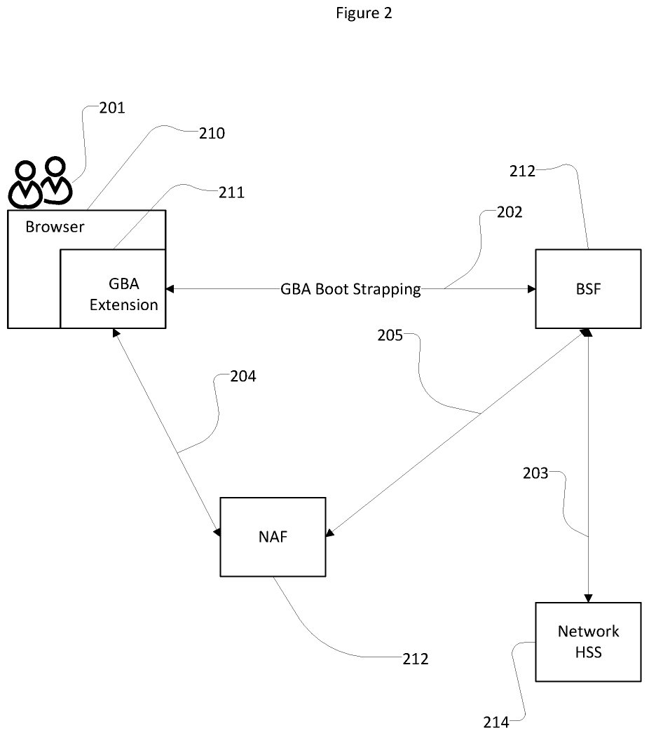

FIG. 2 further show the components used by the GBA flow. For a detailed discussion of the interaction of these components, the reader is guided to the said 3GPP standards noted above. Regardless of the detailed flows executed, all GBA steps will result in the creation of key KsNAF that is provided to each end of the communications channel and said key, being the same at each end, will allow the subject invention to generate the necessary secure tunnel (130) which allows the secure transfer of certificates.

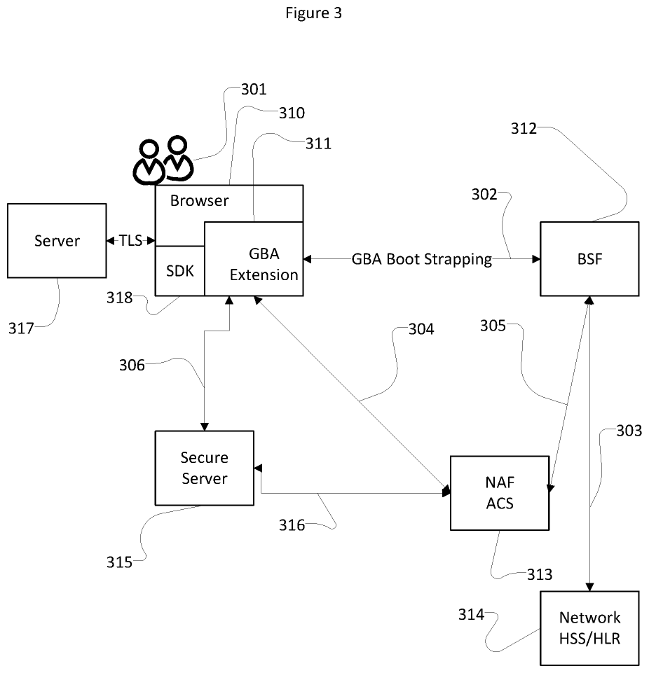

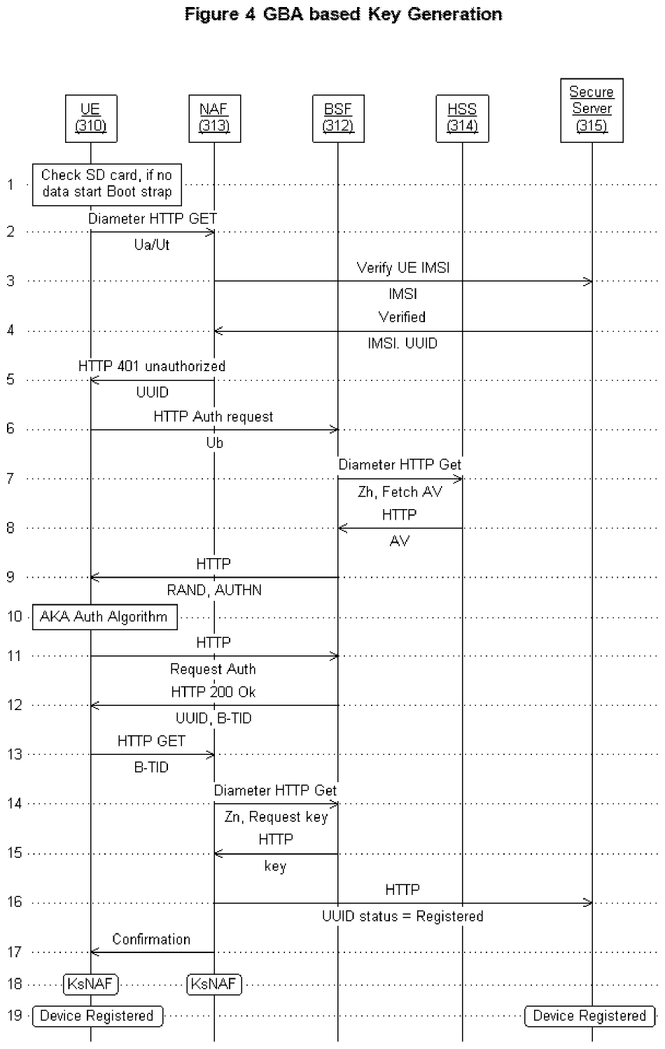

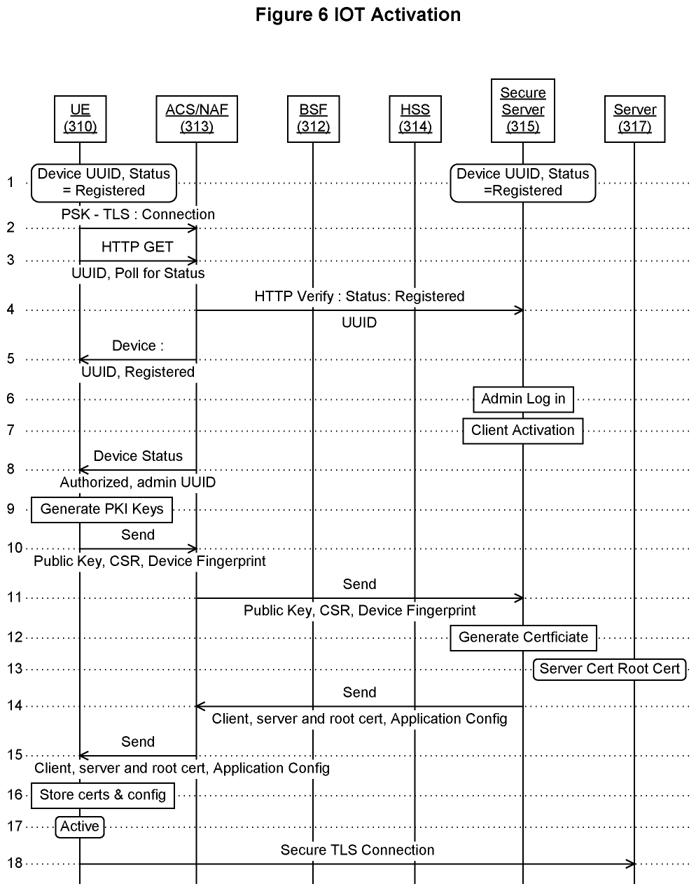

FIG. 3 describes one embodiment of the first part of subject invention based on the GBA standard and is more fully described below together with the message flow diagram FIG. 4. The steps described below correspond to the message numbers on the left side of FIG. 4. The steps below, describe the method to create the commonly known key, KsNAF, known between UE (310) and Secure Server (315). The use of this key to complete the subject invention is further described in FIG. 6.
Step 1. UE (310) Checks local SD Card to determine if it needs bootstrap. It does this by inspecting its local store to verify its status and the presence of the requisite keys, certificates and configuration files.
Step 2. UE (310) connects (302) to the NAF (313) and sends an HTTP GET message using the Diameter Ua/Ut reference point. Attributes of the message include the IMPI and IMSI read from the SIM.
Step 3. NAF (313) contacts Secure Server (315) passing the attribute, IMSI to verify that the device is pre-provisioned.
Step 4. If there is no provisioned device, the bootstrap stops at this point. If there is a device provisioned, then bootstrap proceeds. The deviceID (UUID) is returned as part of the verification process.
Step 5. NAF (313) checks if the HTTP GET message contains HTTP digest authentication parameters. If they are missing or incorrect, the bootstrapping procedure starts and the NAF (313) sends an HTTP 401 (unauthorized) message back to UE (310) with the deviceID (UUID).
Step 6. The UE (310) connects to the BSF (312) using the Diameter Ub reference point and requests a user identity. The BSF (312) address is derived from IMPI (IP multimedia private identity) or IMSI (international multimedia subscriber identity).
Step 7. The BSF (312) fetches the AV (authentication vector) and GUSS (GBA user security settings) of UE (310) from the HSS via Diameter Zh. The GUSS contains several parameters, such as the key lifetime and alternative user ID's, for example, telephone number or email address.
Step 8. The AV contains the following parts:
   RAND (random number)
   AUTN (authentication token)
   XRES (expected response)
   CK (cipher key)
   IK (integrity key)
Step 9. BSF (312) sends the RAND and AUTN to the UE (310).
Step 10. The UE (310) executes the HTTP AKA authentication algorithm as described in well-known 3GPP standards.
Step 11. The UE (310) requests the authorization digest from BSF (312).
Step 12. The BSF (312) sends a 200 OK response message with B-TID (bootstrapping transaction identifier) to the UE (310) which derives session key KsNAF.
Step 13. When UE (310) has verified the response from BSF (312), it sends another HTTP GET message to NAF (313). The message contains the B-TID.
Step 14. NAF (313) requests the authentication data from the BSF (312) via Diameter Zn.
Step 15. NAF (313) receives session key KsNAF.
Step 16. The NAF (313) sends UE bootstrap status to Secure Server (315)
Step 17. The NAF (313) sends a confirmation message to UE (310) indicating that it can now protect the communication with the session key. KsNAF.
Step 18. UE (310) and NAF (313) both have the session key KsNAF
Step 19. UE (310) and Secure Server (315) both have device status as register

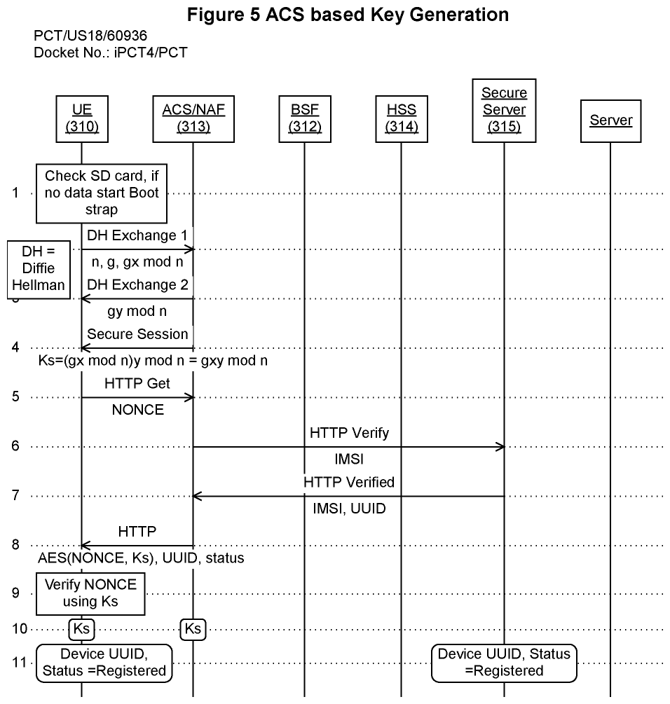

FIG. 5 describes the message flow of a second embodiment of the first part of subject invention based on the ACS standard. Refer to FIG. 3 for the elements. The steps described below correspond to the message numbers on the left side of FIG. 5. The steps below, describe the method to create the commonly known key, Ks, known between UE (310) and Secure Server (315). The use of this key to complete the subject invention is further described in FIG. 6.
Step 1. UE (310) checks local SD Card to determine if it needs bootstrap. It does this by inspecting its local store to verify its status and the presence of the requisite keys, certificates and configuration files.
Step 2. UE (310) begins Diffie Hellman (DH) key discovery protocol by selecting a random number and sending compute vector to the ACS/NAF (313).
Step 3. ACS/NAF (313) receives key vector from UE (310) and selects its own random number and sends a different compute vector to UE (310).
Step 4. Both UE (310) and ACS/NAF (313) independently compute the ephemeral session key Ks.
Step 5. UE (310) connects to ACS/NAF (313) and sends an HTTP GET message to begin authentication. It sends a NONCE as part of the message. A network element (not shown), provides header enrichment by adding IMSI, MSISDN and IP Address to the HTTP GET message as it is processed and passed on to ACS/NAF (313).
Step 6. ACS/NAF (313) verifies that the IP address of the connection is the same as the IP address in the injection. ACS/NAF (313), with message attribute IMSI, connects to Secure Server to verify that the device is pre-provisioned.
Step 7. If there is no provisioned device, the bootstrap stops at this point. If there is a device, then bootstrap proceeds. Secure Server (315) replies to ACS/NAF (313) with the verified status.
Step 8. ACS/NAF (313) returns the device UUID as part of the verification process with the NONCE encrypted by the ephemeral session key Ks.
Step 9. UE (310) decrypts the NONCE using its local session key.
Step 10. UE (310) and ACS/NAF (313) now both have the session key Ks.
Step 11. UE (310) and Secure Server (315) both have device UUID, and device status as register

FIG. 6 describes the how the subject invention uses the first part of embodiment 1 or embodiment 2 and adds the secure connection. Said secure connection then allows the secure transmission of the client and server certificates completing the embodiment of the invention. Together, the description depicted in FIG. 6 with either the first part of embodiment 1 or the first part of embodiment 2 defines an embodiment of this invention. The steps described below correspond to the message numbers on the left side of FIG. 6.
Step 1. Both the UE (310) and Secure Server (315) have the device status as Registered as a result of embodiment 1 or 2 first part.
Step 2. UE (310) and ACS/NAF (313) use the shared session keys to create a PSK-TLS tunnel. All data traversing this link will be encrypted and secure.
Step 3. UE (310) in a registered state, will continually ping the ACS/NAF for a state change. This state change can only happen by the intervention of the Enterprise Administrator.
Step 4. ACS/NAF polls Secure Server if the device status has been changed to either; authorize or reset.
Step 5. UE (310) receives the status from ACS/NAF (313)
Step 6. Enterprise Administrator logs in to the IoT Administration system. In order to do this securely, the admin may use any authentication method including using their mobile phone in which they enter a PIN and their fingerprint biometrics.
Step 7. Client activation is started by the admin.
Step 8. UE (310) continually polls until status changes until administrator activates one or more devices that are currently in register state. UE (310) gets the state change to authorize. The administrator UUID involved in the activation is also returned.
Step 9. UE (310) generates a PKI key-pair using appropriate pre-defined parameters. UE (310) also generates a CSR (Certificate Signing Request) in which the Common Name is the hash of the IMEI and Admin UUID. This allows trace of activating admin by examining the certificate.
Step 10. UE (310) retains the private key and sends the public key, CSR and device fingerprint to the ACS/NAF (313) which in turn forwards the request to Secure Server (315)
Step 11. Secure Server (315) uses the public key and CSR to generate a self-signed certificate using a designated organization as the root authority.
Step 12. Secure Server sends the pre-created Root Certificate and the Server Certificate (also a self-signed cert) to ACS/NAF together with configuration files that are needed—e.g. Server URL and parameters.
Step 13. Server also has the required certificates.
Step 14. Secure Server (315) forwards all certificates to ACS/NAF (313)
Step 15. ACS/NAF (313 forwards all certificates to UE (310)
Step 16. UE (310) stores the certificates and the configuration encrypted with Ks. UE (310) also sets its status to active showing that it has all the connection data and is online
Step 17. UE (310) and Server (317) broker and establish the TLS tunnel. The UE (310) connects to the Server (317) server using the parameters provided and begins processing.

The embodiments described above are effective and practical during the initial activation of UE (310) and the establishment of the secure channel in order to dynamically install certificates. However, should the UE (310) need to be restarted, for any number of reasons including power failure or software reset, the above embodiments may represent additional time or computing power or network capacity that may result in delays in the UE (310) becoming operational. Furthermore, if many devices suffer a common malady (e.g. area wide power failure) with a large plurality of devices that must be restarted, re-establishment of secure connections process may become overloaded. To avoid such difficulties, another embodiment of the subject invention adds the storage of the PKI pairs in a secure manner using Shamir's Secret Sharing algorithm as described in the steps below. Refer to FIG. 3.
Step 1. SDK (318) gets Mobile Push Token over the available mobile network.
Step 2. SDK (318) generates PKI key pair.
Step 3. SDK (318) divides the PKI Key pair into 4/3 (4 Parts, 3 to resolve) using Shamir's Secret Sharing algorithm.
Step 4. SDK (318) keeps Part 1 in local database on device.
Step 5. SDK (318) sends Part 2 and Part 3 of PKI Key to Secure Server (315) over PSK-TLS connection.
Step 6. Secure Server (315) executes a steganographic write of Part 2 of Private Key into the SIM.
Step 7. Secure Serve (315) stores Part 3 of Private Key into local database of the Secure Server.
Step 8. The fourth part is stored by the application.

SDK (318) and the Secure Server (315) setup the PSK-TLS connection each using the same KsNAF or Ks which was generated by SDK (318) and Secure Server (315) independently by each accessing the BSF which has access to the HSS AKA process. The PSK-TLS connection has been securely established without the need to transfer keys or certificates.

Once established, part of the PKI key pair is securely transferred. A further layer of security is added by segmenting the key and storing the segments in different locations. This embodiment assumes that three (3) out of the four (4) parts are needed to recover the key, but the process allows for any number of parts and quorum.

Storage of the PKI pair in the SIM is also possible. While this does not afford the dispersed storage described above, the PKI can also be segmented and stored securely in its entirety on the SIM as described in application PCT/US18/46087 (Secure SIM) which is owned by the same applicant as the subject invention.

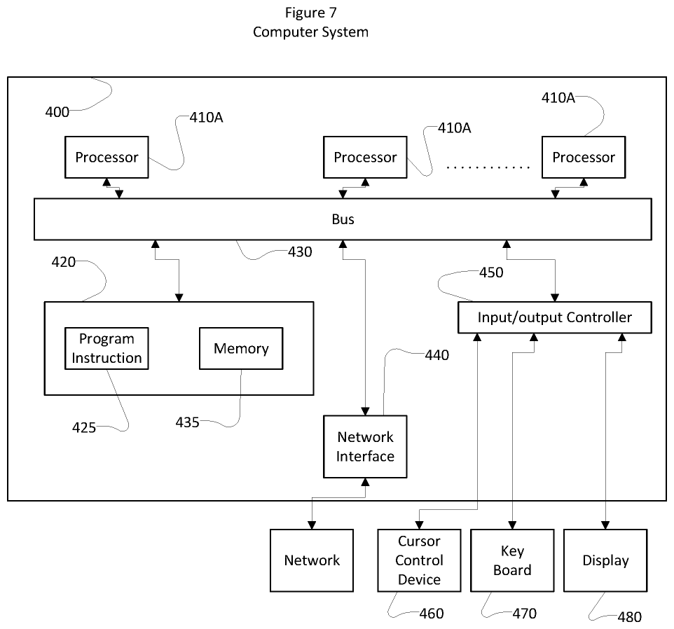

Some embodiments of systems and methods for activating a device and storing the encryption key, as described herein, may be implemented or executed, at least in part, by one or more computer systems. One such computer system is illustrated in FIG. 7. In various embodiments, computer system 400 may be a server, a mainframe computer system, a virtual computer, a network appliance, a workstation, a network computer, a desktop computer, a laptop, a tablet, a handheld device, a mobile device, a smartphone, or the like. For example, in some cases, devices, networks (HSS/HLR) and servers, browsers and network functions (BSF, NAF) as shown in FIGS. 1, 2 and 3 may include at least one computer such as computer system 400. As explained above, in different embodiments these various computer systems may be configured to communicate with each other in any suitable way, such as, for example, via various networks.

As illustrated, computer system 400 includes one or more processors 410A-N coupled to a system memory 420 via bus 440. Computer system 400 further includes a network interface 440 coupled to bus 440, and one or more I/O controllers 450, which in turn are coupled to peripheral devices such as cursor control device 460, keyboard 470, display(s) 480, etc. Each of I/O devices 460, 470, 480 may be capable of communicating with I/O controllers 450, for example, via a wired connection (e.g., serial port, Universal Serial Bus port) or wireless connection (e.g., Wi-Fi, Bluetooth, Near Field Communications Link, etc.). Other devices may include, for example, microphones, antennas/wireless transducers, phone detection modules, etc.

In various embodiments, computer system 400 may be a single-processor system including one processor 410A, or a multi-processor system including two or more processors 410A-N (e.g., two, four, eight, or another suitable number). Processors 410 may be any processor capable of executing program instructions. For example, in various embodiments, processors 410 may be general-purpose or embedded processors implementing any of a variety of instruction set architectures (ISAs), such as the x86, PowerPC®, ARM®, SPARC®, or MIPS® ISAs, or any other suitable ISA. In multi-processor systems, each of processors 410 may commonly, but not necessarily, implement the same ISA. Also, in some embodiments, at least one processor 410 may be a graphics processing unit (GPU) or another dedicated graphics-rendering device.

System memory 420 may be configured to store program instructions and/or data accessible by processor 410. In various embodiments, system memory 420 may be implemented using any suitable memory technology, such as static random-access memory (SRAM), synchronous dynamic RAM (SDRAM), nonvolatile/Flash-type memory, or any other type of memory. As illustrated, program instructions and data implementing certain operations and modules such as those described herein may be stored within system memory 420 as program instructions 425 and data storage 445, respectively. In other embodiments, program instructions and/or data may be received, sent, or stored upon different types of computer-accessible media or on similar media separate from system memory 420 or computer system 400.

A computer-accessible medium may include any tangible and/or non-transitory storage media or memory media such as electronic, magnetic, or optical media—e.g., disk or CD/DVD-ROM coupled to computer system 400 via bus 440. The terms “tangible” and “non-transitory,” as used herein, are intended to describe a computer-readable storage medium (or “memory”) excluding propagating electromagnetic signals but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 440 may be configured to coordinate I/O traffic between processor 410, system memory 420, and any peripheral devices in the computer system, including network interface 440 or other peripheral interfaces, such as I/O devices 460, 470, 480. In some embodiments, bus 440 may perform any necessary protocol, timing, or other data transformations to convert data signals from one component (e.g., system memory 420) into a format suitable for use by another component (e.g., processor 410). In some embodiments, bus 440 may include support for devices attached through various types of peripheral buses, such as a variant of the Peripheral Component Interconnect (PCI) bus standard or the Universal Serial Bus (USB) standard, for example. In some embodiments, the function of bus 440 may be split into two or more separate components, such as a northbridge chipset and a southbridge chipset, for example. In addition, in some embodiments some or all the functionality of bus 440, such as an interface to system memory 420, may be incorporated directly into processor(s) 410A-N.

Network interface 440 may be configured to allow data to be exchanged between computer system 400 and other devices attached to a network, such as other computer systems, or between nodes of computer system 400. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol, including wireless local area networks, WiFi connections, mobile and cellular data networks, and SMS networks.

I/O controllers 450 may, in some embodiments, enable communications with one or more display terminals, keyboards, keypads, touchpads, scanning devices, voice or optical recognition devices, mobile devices, or any other devices suitable for entering or retrieving data by one or more computer system 400. Multiple I/O controllers 450 may be present in computer system 400 or may be distributed on various nodes of computer system 400. In some embodiments, I/O devices may be separate from computer system 400 and may interact with one or more nodes of computer system 400 through a wired or wireless connection, such as over network interface 440.

As shown in FIG. 7, system memory 420 may include program instructions 425, configured to implement certain embodiments described herein, and data storage 445, comprising various data may be accessible by program instructions 425. In an embodiment, program instructions 425 may include software elements, which may be configured to affect the operations discussed in FIGS. 1, 2 and 3. Program instructions 425 may be implemented in various embodiments using any desired programming language, scripting language, or combination of programming languages and/or scripting languages (e.g., C, C++, C #, Java™ JavaScript™, Perl, etc.). Data storage 445 may include data that may be used in these embodiments (e.g., recorded communications, profiles for different modes of operations, etc.). In other embodiments, other or different software elements and data may be included.

A person of ordinary skill in the art will appreciate that computer system 400 is merely illustrative and is not intended to limit the scope of the disclosure described herein. The computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations including virtual configurations.

It should be understood that the various operations described herein, particularly in connection with FIGS. 1, 2 and 3, may be implemented in software executed by processing circuitry, hardware, or a combination thereof. The order in which each operation of a given method is performed may be changed, and various operations may be added, reordered, combined, omitted, modified, etc. It is intended that embodiment(s) described herein embrace all such modifications and changes and, accordingly, the above description should be regarded in an illustrative rather than a restrictive sense.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A method for activating a device, installing security certificates and establishing an application to server secure connection without the need to transmit said certificates without encryption or physically transferring said certificates or installing said certificates at time of manufacture by;
activating a standard 3GPP activation boot strap authentication process to connect to the mobile network;
extracting the key created during said boot strap authentication process;
using said key to establish a secure tunnel;
transmitting said certificates over said tunnel;
installing said certificates in said application and said server;
storing the necessary PKI pairs securely;
and
creating said secure connection between said application and said server.

2. A method as in claim 1, wherein the 3GPP activation boot strap authentication process is the GBA process.

3. A method as in claim 1, wherein the 3GPP activation boot strap authentication process is the ACS process.

4. A method as in claim 1, wherein said PKI pairs are segmented into parts said parts being stored in different locations.

5. A method as in claim 4, wherein said PKI pairs are divided according to Shamir's Secret Sharing algorithm.

6. A method as in claim 1, wherein said device is already activated.

7. A method as in claim 1, wherein said PKI pair is securely stored on the SIM only.
